(19) United States
(12) Patent Application Publication
(10) Pub. No.: US 2021/0339125 A1
(43) Pub. Date: Nov. 4, 2021

(54) GAME DEVICE

(71) Applicant: MARVELOUS INC., Tokyo (JP)

(72) Inventor: Shingo DOTE, Tokyo (JP)

(21) Appl. No.: 17/282,364

(22) PCT Filed: Oct. 2, 2018
(86) PCT No.: PCT/JP2018/036773

§ 371 Date: Apr. 1, 2021

(51) Int. Cl. A63F 13/245; A63F 13/814; A63F 13/2145; A63F 13/44

(52) U.S. Cl. CPC A63F 13/245; A63F 13/814; A63F 13/2145; A63F 2300/8047; A63F 2300/1043; A63F 2300/1075; A63F 2300/638; A63F 13/44

(57) ABSTRACT

A game device is provided. Such a game device includes an operation unit for receiving an operation input from a player, a display unit for displaying an image for instructing the operation input to the operation unit; and a control unit for controlling display of the image. At least a part of the operation unit is provided at the vicinity of the display unit so as to protrude from the display unit. This configuration makes it possible to give a player a sense of immersion and a sense of spurting of a video game.

### TECHNICAL FIELD

The present invention relates to a game device.

### BACKGROUND ART

Conventionally, there has been known a game (video game) in which a player operates an operation unit of a game device in accordance with music. Such a video game is referred to as a so-called music game. The music game is not only played by using a personal digital assistance, but also played by using a game device provided in an amusement facility (for example, Patent Document 1).

For example, the game device disclosed in Patent Document 1 includes a circular monitor and operation buttons provided at intervals around the circular monitor. Since the monitor and the operation buttons are formed on substantially the same plane, the player obtains information around the game device unnecessarily during the game. For this reason, the game device lacks an aggressive sense of the game and cannot provide the player with concentration to the game.

### PRIOR ART DOCUMENTS

### PATENT DOCUMENTS

Patent document 1: JP 6115746 B

### SUMMARY OF THE INVENTION

### Problems To Be Solved By The Invention

It is an object of the present invention to provide a game device which is capable of giving a player a sense of immersion to a game and a sense of spurting of the game.

### Means For Solving The Problems

Such an object is achieved by the present inventions (1) to (10) described below.

(1) A game device comprising:

an operation unit for receiving an operation input from a player;

a display unit for displaying an image for instructing the operation input to the operation unit; and

a control unit for controlling display of the image,

wherein at least a part of the operation unit is provided at the vicinity of the display unit so as to protrude from the display unit.

(2) In the game machine described in the above-mentioned invention (1), the operation unit is provided on the display unit.

(3) in the game machine described in the above-mentioned invention (1) or (2), the operation unit is formed into a cylindrical shape.

(4) In the game machine described in any one of the above-mentioned inventions (1) to (3), a protrusion angle of the operation unit with respect to the display unit is in the range of 90 to 150°.

(5) In the game machine described in any one of the above-mentioned inventions (1) to (4), the operation unit is constituted from a plurality of operation members arranged in series.

(6) In the game machine described in the above-mentioned invention (5), the operation unit includes a cylindrical main body and the plurality of operation members, and the plurality of operation members is arranged along an inner peripheral surface of the main body.

(7) In the game machine described in the above-mentioned invention (5) or (6), the image includes a plurality of instruction images, and the plurality of operation members are provided so as to correspond to the plurality of instruction images in a direction in which the plurality of instruction images moves.

(8) In the game machine described in any one of the above-mentioned inventions (5) to (7), the plurality of operation members is divided into a plurality of areas along a longitudinal direction thereof.

(9) In the game machine described in any one of the above-mentioned inventions (5) to (8), at least one operation member of the plurality of operation members includes a plurality of touch sensors as a detection device.

(10) In the game machine described in any one of the above-mentioned inventions (5) to (9), a length of the plurality of operation members is 50 to 150% with respect to a distance in which the plurality of instruction images moves.

### Effects Of The Invention

According to the present invention, it is possible to provide the game device which is capable of giving the player with the sense of immersion to the game and the sense of spurting of the game.

### BRIEF DESCRIPTION OF THE DRAWINGS

FIG. 1 is a perspective view schematically showing a game device according to a first embodiment of the present invention.

FIG. 2 is an enlarged view schematically showing an operation unit and a display unit of the game device according to the first embodiment of the present invention.

FIG. 3 is a block diagram showing a configuration of the game device according to the first embodiment of the present invention.

FIG. 4 is a view showing an instruction image pattern stored in a storage unit of the game device according to the first embodiment of the present invention.

FIG. 5 is a view showing a determination table stored in a storage unit of the game device according to the first embodiment of the present invention.

FIG. 6 is views showing success area tables stored in the storage unit of the game device according to the first embodiment of the present invention.

FIG. 7 is an enlarged view showing operation members of the operation unit of the game device according to the first embodiment of the present invention.

FIG. 8 is a view for explaining a basic operation of the game device according to the first embodiment of the present invention.

FIG. 9 is a view for explaining the basic operation of the game device according to the first embodiment of the present invention.

FIG. 10 is a view for explaining a slide operation of the game device according to the first embodiment of the present invention.

FIG. 11 is a view for explaining a snap operation of the game device according to the first embodiment of the present invention.

FIG. 12 is a view for explaining a hold operation of the game device according to the first embodiment of the present invention.

FIG. 13 is a view for explaining a chain operation of the game device according to the first embodiment of the present invention.

FIG. 14 is a flowchart showing a flow of a game processing of the game device according to the first embodiment of the present invention.

FIG. 15 is a flowchart showing a flow of the slide operation of the game device according to the first embodiment of the present invention.

FIG. 16 is a flowchart showing a flow of the snap operation of the game device according to the first embodiment of the present invention.

FIG. 17 is a perspective view schematically showing a game device according to a second embodiment of the present invention.

FIG. 18 is a perspective view schematically showing a game device according to a third embodiment of the present invention.

### DESCRIPTION OF THE EMBODIMENTS

Hereinafter, a game device of the present invention will be described in detail based on preferred embodiments with reference to the accompanying drawings. In the following description, for the convenience of explanation, the upper side in each figure will be referred to as “upper”, the lower side thereof will be referred to as “lower”, the left side thereof will be referred to as “left”, the right side thereof will be referred to as “right”, the near side of the page will be referred to as “front” and the back side of the page will be referred to as “back”.

### First Embodiment

### 1. Game Device

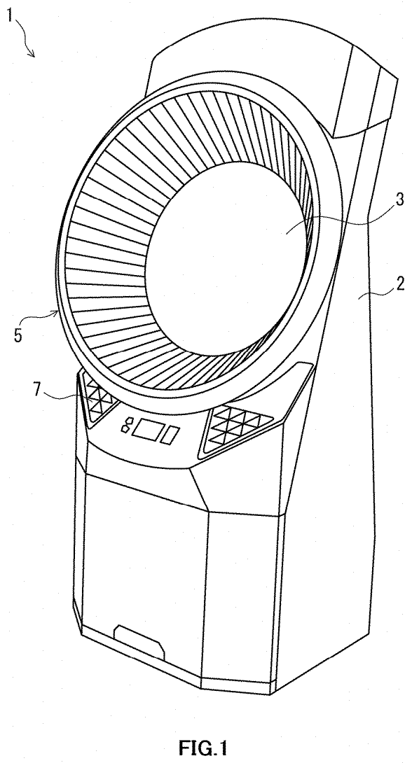

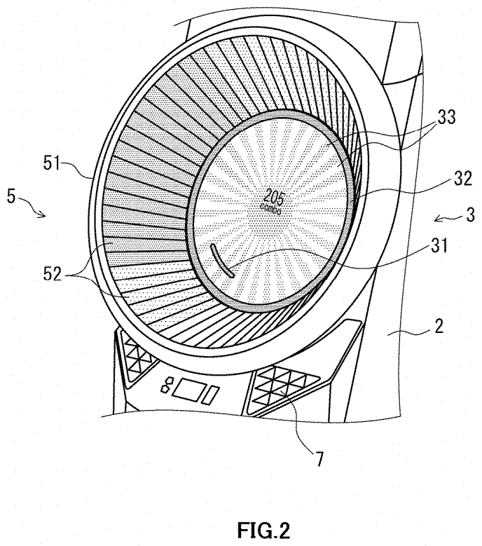

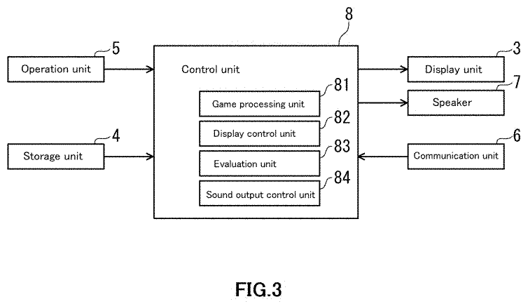

FIG. 1 is a perspective view schematically showing a game device according to a first embodiment of the present invention. FIG. 2 is an enlarged view schematically showing an operation unit and a display unit of the game device according to the first embodiment of the present invention. FIG. 3 is a block diagram showing a configuration of the game device according to the first embodiment of the present invention.

The game device 1 of the present invention as shown in FIG. 1 is a game device to be located in an amusement facility or the like. However, the game device 1 of the present invention is not limited thereto, and can also be applied to a video game device for home use. The game device 1 plays music and displays a predetermined image in accordance with the music. A player operates the game device 1 in accordance with the music and the predetermined image. An evaluation for an operation of the player by the game device 1 excites the player during a game.

Such a game device 1 of the present invention includes a housing 2, a display unit 3, a storage unit 4, an operation unit 5, a communication unit 6, a speaker 7, and a control unit 8. Hereinafter, description will be made on a configuration of each unit of the game device 1.

### Housing

The housing 2 has a function of installing or accommodating each member of the game device 1. As shown in FIG. 1, the housing 2 is formed into a box shape. However, a shape of the housing 2 is not particularly limited. An upper front surface (first surface) of the housing 2 is inclined to a back (second surface) side with respect to a vertical axis. As a result, it is possible for all players to comfortably view the display unit 3. In addition, it is possible to install the operation unit 5 so as to be easy to operate.

### Display Unit

The display unit 3 has a function of displaying an image related to the game (video game). The display unit 3 is provided on the front surface of the housing 2 of the game device 1 as shown in FIG. 1. The display unit 3 may be constituted from one panel, a plurality of panels, or one panel divided into the plurality of panels. Further, the display unit 3 may be a touch panel. As shown in FIG. 1, the display unit 3 is formed into a circular shape. However, the display unit 3 is not limited thereto, and may be formed into a rectangular shape or a triangular shape.

As shown in FIG. 2, the display unit 3 includes a game area in which a plurality of instruction images (hereinafter, referred to as “notes”) 31 are displayed and a determination area in which a determination line (also referred to as an instruction image) 32 is displayed. The game area is constituted from a vanishing point located at the center of the display unit 3, the notes 31 and a plurality of lanes 33 extending radially from the vanishing point.

The notes 31 have a function of instructing the player an operation input when the notes overlap on the determination line 32. The notes 31 include normal notes, slide notes, snap notes, hold notes and chain notes. The function of each of the notes will be described later. The vanishing point is a point at which the notes 31 appear, and located at the center of the display unit 3.

The plurality of lanes 33 are lanes on which the notes 31 move and which extend linearly from the vanishing point to the determination line 32. The plurality of lanes 33 are provided corresponding to operation members 52 to be described later along a direction in which the notes 31 move. Thus, since the notes 31 move so as to approach from the disappearance point, it is possible to give the player the sense of immersion to the game. A width of each of the lanes 33 becomes wider toward the determination line 32. In this embodiment, sixty lanes 33 are formed from the vanishing point toward the determination line 32. It is to be noted that the plurality of lanes 33 may not be displayed and may extend in a curved shape or a zigzag shape.

The determination line 32 has a function of instructing the player to make the operation input when the notes 31 overlap the determination line 32. The determination line 32 is formed along circumference of the display unit 3 and into an annular shape. The determination line 32 is divided so as to correspond to the plurality of lanes 33. Therefore, the determination line 32 is also divided into sixty parts corresponding to the plurality of lanes 33. It is noted that the determination line 32 may not be displayed and the determination line 32 may not be provided. Further, the determination line 32 is not limited to the annular shape and may be a straight shape or may be formed into a ring shape individually corresponding to each lane 33.

### Storage Unit

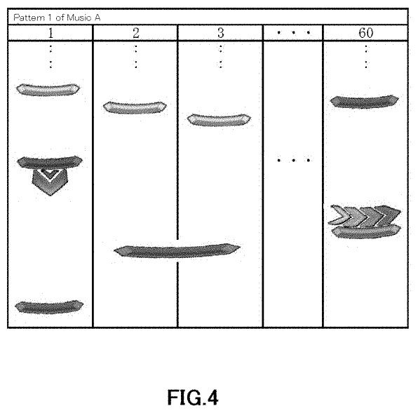

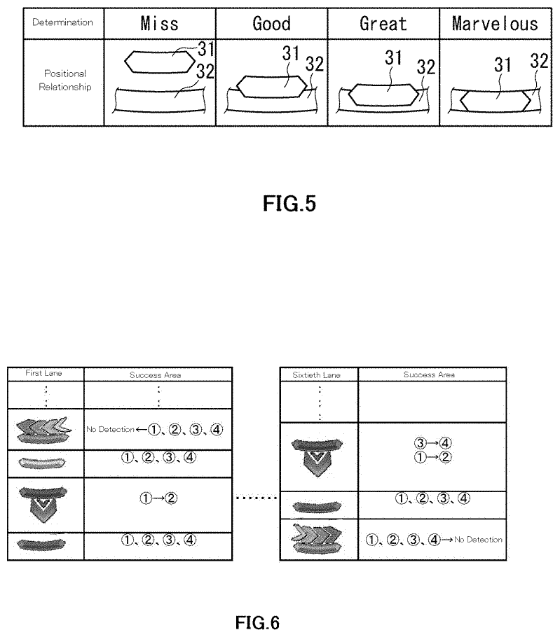

Next, description will be made on the storage unit 4. FIG. 4 is a view showing an instruction image pattern stored in a storage unit of the game device according to the first embodiment of the present invention. FIG. 5 is a view showing a determination table stored in a storage unit of the game device according to the first embodiment of the present invention. FIG. 6 is views showing success area tables stored in the storage unit of the game device according to the first embodiment of the present invention.

The storage unit 4 stores a game program and game data. The game program is a program for causing the game device 1 to execute the game and is implemented by cooperation with a hardware. The game data are data related to the game and include music data, image data, sound effect data and instruction image pattern data.

The music data are sound data coming from the speaker 7. Examples of the music data include a plurality of sound data such as songs of singers, animation songs and the like.

The image data are related to the game and are displayed on the display unit 3. Examples of the image data include data such as a notes image, a lane image, a determination line image, and various effect images. The notes image has a supplementary image for instructing various operations. For example, the supplementary image includes a rightward supplementary image for instructing a right slide operation, a leftward supplementary image for instructing a left slide operation, an upward supplementary image for instructing an upward snap operation, a downward supplementary image for instructing a downward snap operation, and a hold supplementary image for indicating a hold operation (see FIG. 4).

The sound effect data are sound data to be played during the game play, which are different from the music data. Examples of the sound effect data include evaluation sound data that come in accordance with an operation result of the player. Such evaluation sound data include sound data at the time of succeeding in the operation and sound data at the time of failing to operate.

The instruction image pattern data are data showing a pattern in which the notes 31 appear on the plurality of lanes 33 during one music (sound). The instruction image pattern data correspond to one music. The storage unit 4 stores such instruction image pattern data depending on the number of music. For example, FIG. 4 shows the indication image pattern data corresponding to the music A. The numbers 1 to 60 are assigned in the plurality of lanes 33 respectively, and each lane 33 contains a pattern of notes 31 to appear. The notes 31 make a line in the order of time from the start to the end of the music. FIG. 4 means that the lower the notes 31 move, the more the notes 31 appear at the beginning of the music.

Specifically, when the music starts, first, the normal notes appear on the first lane. Next, the normal notes appear across the second and third lanes, and then right slide notes appear on the sixtieth lane. In accordance with such an instruction image pattern, the notes 31 move on each of the lanes 33 until the music ends.

The instruction image pattern data may have various types of patterns for one music. The various types of patterns may be classified depending on a difficulty level. Further, the instruction image pattern data may be stored in correspondence with a moving speed of the notes 31. Thus, it is possible to change the moving speed in addition to the different patterns, and therefore it is possible to further raise the difficulty level of the game.

The instruction image pattern includes the five types of notes 31 described above. The normal notes instruct a tap operation. The slide notes instruct a slide operation in either a left-right direction and have the leftward supplementary image or the rightward supplementary image. The snap notes instruct the slide operation in either a vertical direction and have the upward supplementary image or the downward supplementary image. The hold notes instruct to continue to touch the notes and have the hold supplementary image. The chain notes are notes 31 to instruct to operate the notes 31 in succession.

The storage unit 4 stores criteria for determining success of the operation input by the player. In other words, the storage unit 4 stores a positional relationship between the determination line 32 and the notes 31, and the determination result in the determination table in association with each other. FIG. 5 shows that the determination result differs depending on that the operation input is received at any position of the notes 31 with respect to the determination line 32.

Specifically, when the notes 31 are at a position far from (not in contact with) the determination line 32, the positional relationship is associated with the determination result “Miss”. When the notes 31 are at a position marginally away from (in contact with) the determination line 32, the positional relationship is associated with the determination result “Good”. When the notes 31 are at a position slightly away from (in contact with) the determination line 32, the positional relationship is associated with the determination result “Great”. When the notes 31 and the determination line 32 are at the almost overlapping position, the positional relationship is associated with the determination result “Marvelous”.

In addition, the storage unit 4 stores the success areas of the operation members 52 for each of the notes 31. In other words, the storage unit 4 stores tables (success area tables) in which the notes 31 in the instruction image pattern data and the success areas of the operation members 52 are associated with each other for each lane 33. For example, as shown in FIG. 6, in the case of the normal notes, first to fourth areas 521 to 524 of each operation member 52 are shown to be the success areas. In other words, the normal notes shows that the operation is successful even if any positions of the operation member 52 are operated. This is also applied to the cases of the chain notes and the hold notes.

Further, in the case of the left slide notes in the first lane, it is shown as the success areas to operate in the left direction from any of the first to fourth areas 521 to 524 of a first operation member 52 corresponding thereto. In other words, the left slide notes show as a success a case where the operation is performed from any position of the operation member 52 to the left side and the operation input on the operation member 52 is no longer detected. This is also applied to the case of the right slide notes.

In the case of the lower snap notes, the first lane shows that the continuous operation (slid operation or tap operation) in the combination from the first area 521 to the second area 522 of the first operation member 52 corresponding thereto is the success areas. On the other hand, the sixtieth lane shows that the continuous operations in combinations from the first area 521 to the second area 522 and from the third area 523 to the fourth area 524 of the sixtieth operation member 52 corresponding thereto are the success areas. This is also applied to the case of the upper snap notes.

The combinations of the success areas may include a combination of adjacent areas and combinations of separated areas other than the combination. The combination of the adjacent areas includes a combination from the second area 522 to the third area 523, a combination from the third area 523 to the fourth area 524 and the like. The combinations of the separated areas include a combination of the first area 521 and the third area 523, and the like.

### Operation Unit

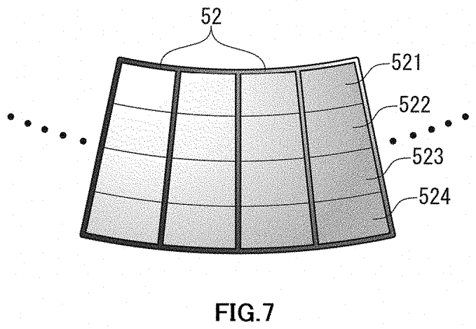

Next, description will be made on the operation unit 5. FIG. 7 is an enlarged view showing operation members of the operation unit of the game device according to the first embodiment of the present invention. The operation unit 5 has a function of receiving the operation input to be performed by the player to execute the game. The operating unit 5 is formed into a cylindrical shape, in particular the cylindrical shape having a truncated cone shape. However, the shape of the operation unit 5 is not particularly limited and may be the cylindrical shape, a box-shaped shape, a triangular cylindrical shape, or the like. The operation unit 5 is provided at the upper front surface of the housing 2 and at the vicinity of the display unit 3 so as to protrude from the display unit 3.

The operation unit 5 includes a main body having the cylindrical shape and a plurality of elongated operation members 52. The main body 51 has a function of supporting the operation members 52. In the present embodiment, the main body 51 is formed into the cylindrical shape of the truncated cone shape, but is not limited thereto. Since the main body 51 is formed into the cylindrical shape, the main body 51 has an upper bottom opening (first opening) of a circular shape and a lower bottom opening (second opening) of which area is larger than that of the upper bottom opening. A diameter of the upper bottom opening is not particularly limited, but is preferably in the range of 40 to 80 cm, more preferably in the range of 50 to 70 cm. Further, a diameter of the lower bottom opening is not particularly limited, but is preferably in the range of 80 to 150 cm, and more preferably in the range of 90 to 120 cm. Such a diameter makes it possible for the player to reliably view the display unit 3.

The operation unit 5 is provided on the display unit 3 so that the upper bottom opening thereof is encompassed in the display unit 3. This makes it possible for the player to visually recognize the display unit 3 through the upper bottom opening of the operation unit 5.

The plurality of elongated operation members 52 have a function of receiving the operation input from the player. The plurality of operation members 52 are continuously provided on an inner peripheral surface of the main body 51. However, the arrangement of the operation members 52 is not limited thereto. The operation members 52 may be intermittently provided along the inner peripheral surface of the main body 51. The number of the operation members 52 is not particularly limited, but is set to 60 in the present embodiment. This corresponds to the number of lanes 33 displayed on the display unit 3.

A shape of each of the operation members 52 is not particularly limited, and includes a plate shape, a disc shape, a block shape, a rod shape, an annular shape, and the like. In the present embodiment, the operation members 52 are formed into an elongated plate shape. Length of the operation member 52 is not particularly limited, but is preferably in the range of 150 to 350 cm, and more preferably in the range of 200 to 300 cm. In other words, the length of the operation member 52 is preferably in the range of 50 to 150% with respect to a distance that the notes 31 move, namely, the radius of the display unit 3, and more preferably in the range of 60 to 140%. Such length makes it possible to perform the slid operation from the front to the back and from the back to the front of the game device 1, thereby enhancing amusement of the game.

Further, these operation members 52 are provided so as to correspond to the lanes 33 and notes 31 displayed on the display unit 3 along a longitudinal direction (in moving direction of the notes 31) of the operation members 52. Therefore, the total length of the length of each lane 33 and the length of each operation member 52 makes it possible to give the player a sense of depth of the game device 1, so that it is possible to enhance the sense of immersion to the game and the sense of spurting of the game.

A protrusion angle of each of the operation member 52 with respect to the display unit 3 is preferably in the range of 90 to 150° and more preferably in the range of 100 to 140°. As a result, the operation members 52 are spread from the display surface in a flared manner, and thus it is possible to give the player the sense of immersion to the game. In addition, it is possible to give the player an impression that the notes 31 move to the operation members 52 beyond the lanes 33, so that it is possible to give the player the sense of spurting of the game.

The operation members 52 have an electrostatic touch sensor for detecting the operation input as a detection device. The number of electrostatic touch sensor may be one or a plurality of two or more. However, the number thereof is preferably in the range of 1 to 10, more preferably in the range of 1 to 5, and even more preferably in the range of 1 to 4. Thus, even if the player operates any areas of the elongated operation members 52, it is possible to reliably detect the operation. The electrostatic touch sensor is provided on a surface (rear surface) on the side of the main body 51 of each operation member 52. The touch sensor provided in the operation member is not limited to the electrostatic touch sensor and may be any detection device capable of detecting the operation input by touching of the player. Examples of such a device include an ultrasonic surface acoustic wave system sensor, a resistive film type sensor, a projection type infrared type sensor and the like.

The operation members 52, as shown in FIG. 7, are divided into a plurality of areas along its longitudinal direction. The number of areas is not particularly limited, but is divided into four areas in the present embodiment as shown in FIG. 7. Thus, since the electrostatic touch sensor can be provided in each area, it is possible to evaluate the operation input of the player in each area of the operation member 52. Specifically, the back surfaces of the operation members 52 are divided into four along the longitudinal direction of the operation members 52 as shown in FIG. 7. The operation members 52 form a first area 521, a second area 522, a third area 523, and a fourth area 524 from the side of the display unit 3. The electrostatic touch sensor is provided in each of these areas one by one. With such a configuration, it is possible to detect the slid operation in the longitudinal direction accurately and reliably, so that it is possible to increase the variation of the evaluation of the operation input. Accordingly, it is possible to provide the game that an advanced-level player can enjoy.

In the present embodiment, the operation members 52 are divided into the four areas, but the division is not limited to the four areas. By increasing the number of divisions, it is possible for the player to obtain a smooth operation feeling while increasing variations in the evaluation of the operation input. More specifically, as the number of divisions increases, the number of combinations of areas and the number of combinations of adjacent areas can be increased. Thus, it is possible to increase the variations in the operation input.

In addition, by dividing the operation members 52 into at least two parts, it becomes possible to perform the operation of straddling the area on one operation member 52. If the number of divisions is 3 or more, it is possible to make the snap operation or the like to be described later more easily. For example, in the cases of three divisions and eight divisions of the operation member 52, the case of the eight divisions compared with the case of the three divisions become possible to succeed in the snap operation with a small movement of hands as well as to reduce the movement of the player's hand.

Incidentally, all the plurality of operation members 52 may be divided into a plurality of areas, or at least a part of the operation members 52 among all the plurality of operation members 52 may be divided into the plurality of areas. In the present embodiment, the operation members (thirty operation members) 52 positioned on the lower inner peripheral surface of the main body 51 are divided into the four areas. In other words, in the present embodiment, the operation members (thirty operation members) 52 positioned on the upper inner peripheral surface of the main body 51 may not be divided into the plurality of areas. However, all the operation members 52 may be divided into the plurality of areas over the entire circumference of the inner peripheral surface of the main body 51. In this case, it is possible to provide more operational variations.

Similarly, a plurality of electrostatic touch sensors may be provided in each of the plurality of areas of all the operation members 52 or the plurality of electrostatic touch sensors may be provided in each of the plurality of areas of some operation members 52. In the present embodiment, four electrostatic touch sensors are provided in the four areas of the operation members 52 positioned on the lower inner peripheral surface of the main body 51. In other words, each of the operation members 52 positioned on the upper inner peripheral surface of the main body 51 is provided with only one electrostatic touch sensor. When the operation member 52 is divided into a plurality of areas, only one electrostatic touch sensor may be provided in any one of the areas.

### Communication Unit

The communication unit 6 has a function of communicating with an external network (LAN, WAN, Internet, etc.) or a device by wired or wireless access. The game device 1 of the present invention may perform data communication with other devices such as another game device or an information terminal via the communication unit 6. For example, the communication unit 6 can communicate with the other devices to obtain the music data and the game program. This makes it possible to update the music data to provide the latest music.

### Speaker

The speaker 7 has a function of outputting various sounds. Speaker 7 is provided on a front lower portion of the housing 2. The number of the speakers 7 is not particularly limited, and may be one or 2 or more. In the present embodiment, one speaker 7 is provided on each of both sides of the front lower portion of the housing 2. The sound output from the speaker 7 includes the music stored in the storage unit 4, the sound effects provided by executing the game program, and the like.

### Control Unit

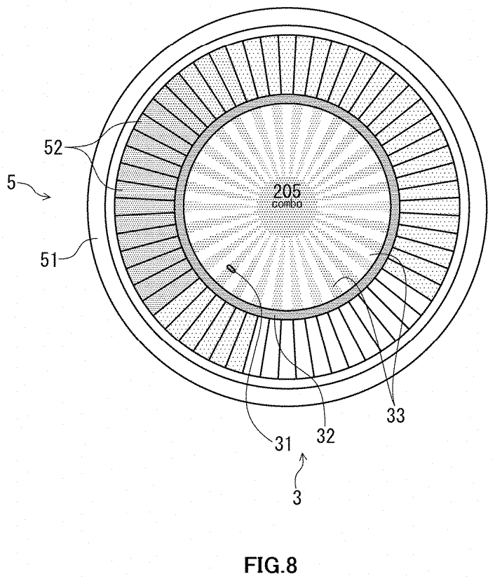

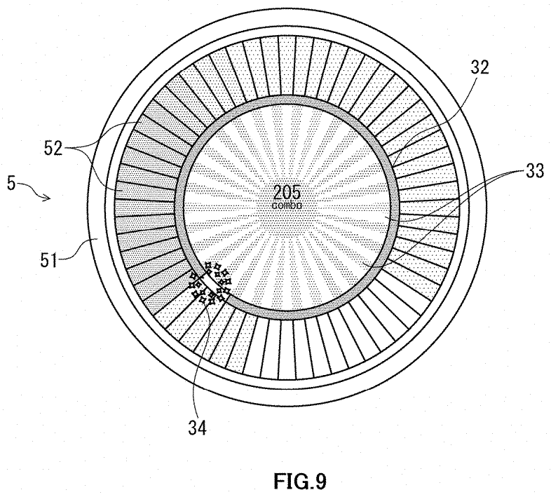

Next, description will be made on the control unit 8. FIG. 8 is a view for explaining a basic operation of the game device according to the first embodiment of the present invention. FIG. 9 is a view for explaining the basic operation of the game device according to the first embodiment of the present invention. The control unit 8 has a function of executing game processing. More specifically, in the present invention, the instruction image 31 is displayed on the display unit 3 while playing the music, and then the operation input is received from the player. Then, the processing of evaluating the operation by the player is performed. Such a control unit 8 has a game processing unit 81, a display control unit 82, an evaluation unit 83, and a sound output control unit 84 as shown in FIG. 3.

The game processing unit 81 has a function of acquiring information of the operation input by the player and processing the information. For example, the game processing unit 81 performs to determine and provide the music stored in the storage unit 4, and determine and provide the instruction image pattern corresponding to the music based on the operation input by the player. Specifically, when the operation unit 5 receives the operation input for selecting the music by the player, the game processing unit 81 determines the music from the music group stored in the storage unit 4. Then, the game processing unit 81 provides the determined music to the sound output control unit 84. At the same time, the game processing unit 81 provides the instruction image pattern corresponding to the determined music to the display control unit 82 as shown in FIG. 4. As a result, the sound output control unit 84 described later outputs the music, and then the display control unit 82 controls to display the instruction image pattern corresponding to the music.

It is noted that the game processing unit 81 may randomly determine the music without the basis of the selection operation of the music by the player. Further, when a plurality of instruction image patterns corresponds to one music, the game processing unit 81 can determine an arbitrary pattern at random among the plurality of instruction image patterns.

In addition, the game processing unit 81 executes functions of acquiring the information of the operation input by the player and providing the information. Specifically, the game processing unit 81 acquires the information of the operation input, and then provides the information to the evaluation unit 83. At the same time, the game processing unit 81 provides the information to the display control unit 82. This makes it possible for the evaluation unit 83 to evaluate the operation based on the criteria for determining the success shown in FIG. 5.

The display control unit 82 has a function of controlling the display of all images related to the game. That is, the display control unit 82 controls the display of the instruction image pattern determined by the game processing unit 81 and the display of the image based on the evaluation result made by evaluation unit 83. For example, the display control unit 82 controls the display of the instruction image so that the normal notes move toward the determination line 32 from the vanishing point as shown in FIG. 8. Then, as shown in FIG. 9, the display control unit 82 controls the display of the evaluation image 34 showing the evaluation of the player's operation by the evaluation unit 83. The display control unit 82 may control to display character images (evaluation images) such as “Miss”, “Great”, “Marvelous” and “Good”, which show the evaluation of the operation and are made by the evaluation unit 83.

The evaluation unit 83 has a function of evaluating a position and a timing of the operation input by the player. The evaluation unit 83 first evaluates the operation from the information of the operation input acquired by the game processing unit 81 and the success area table. In other words, the evaluation unit 83 compares the information acquired on the area of the operation member 52 with the success area table for each of the notes 31, and then evaluates whether or not the operation is successful.

Specifically, in the case of normal notes, even if the operation input from any areas 521 to 524 of the operation members 52 is received, the evaluation unit 83 evaluates the operation as the success with reference to FIG. 6. Further, in the case of snap notes, if the continuous input in the adjacent operation areas on the operation member 52 is received, the evaluation unit 83 evaluates the snap operation as the success (first success) with reference to FIG. 6. In the case of the slide notes, after the operation input on any of the areas 521 to 524 of the operation member 52 is detected and when the operation input is no longer detected in the operation member 52, the evaluation unit 83 evaluates the slide operation as the success (the third success) with reference to FIG. 6.

In such a slide operation or snap operation, when the information of the operation input does not correspond to the success area of the success area table of FIG. 6, the evaluation unit 83 does not evaluate as the slide operation or the snap operation as the success, but evaluates as a normal operation success (second success). In this case, regardless of the result of the timing-based evaluation, a worse evaluation “Good” is made for the operation.

After evaluating the operation based on the success area, the evaluation unit 83 evaluates the positional relationship between the determination line 32 and the notes 31. In other words, the evaluation unit 83 evaluates the timing of the input from the information of the operation input obtained by the game processing unit 81 and the determination table. Specifically, in the case where the game processing unit 81 acquires the information of the operation input when the notes 31 are at the position far away from (not in contact with) the determination line 32 as shown in FIG. 5, the evaluation unit 83 evaluates the input operation as “Miss” based on the determination table. Similarly, in the case where the game processing unit 81 acquires the information of the operation input when the notes 31 and the determination line 32 are marginally apart from (in contact with) each other, the evaluation unit 83 evaluates the input operation as “Good” based on the determination table. Furthermore, in the case where the game processing unit 81 acquires the information of the operation input when the notes 31 almost overlap with the determination lines 32, the evaluating unit 83 evaluates the input operation as “Marvelous” based on the determination table. In this manner, the evaluation unit 83 evaluates the operation of the player based on the criteria for determining in the four steps.

The sound output control unit 84 controls the output of all sounds and music related to the game. Specifically, the sound output control unit 84 controls the output of the music determined by the game processing unit 81. Further, the output of the evaluation sound data is controlled based on the evaluation result.

In addition to the configuration as described above, the control unit 8 of the present invention may include a display mode changing unit which has a function of changing the size of the notes 31. For example, one notes 31 corresponds to one lane 33 as shown in FIG. 8. However, in order to raise the difficulty level of the game, the display mode changing unit can change the size of the notes 31 to the range of 20 to 80% (predetermined ratio) of the size of one lane 33. In addition, the display mode changing unit may change the size so that one notes 31 is displayed over (across) the plurality of lanes (e.g., two lanes) 33, and may change the size of the notes 31 to the range of 20 to 80% of the size of the lanes corresponding to the plurality of lanes. That is, regardless of the size of the notes 31, it is possible to change the size of the notes 31 to a size obtained by reducing by a predetermined ratio with respect to the width of the lane 33.

For example, as shown in FIG. 2, when one notes 31 is displayed over six lanes, the display mode changing unit can reduce the size of the notes 31 by 50% of the lanes 33 located outside. In other words, in the case of the notes (coupling notes) 31 displayed over the plurality of lanes 33, the display mode changing unit can change the coupling notes 31 to the notes 31 having the size reduced by one lane in the entire coupling notes 31. As a result, even if the operation members 52 corresponding to both ends of the notes 31 are operated, it is possible give the player an impression not to be evaluated, and it is possible to enhance the difficulty level of the game.

Although the game device 1 of the present invention has been described above, the game device 1 of the present invention includes a coin insertion slot, a coin return slot and the like in addition to the configurations the as described above.

### 2. Evaluation Method of Operation Input for Every Instruction Image

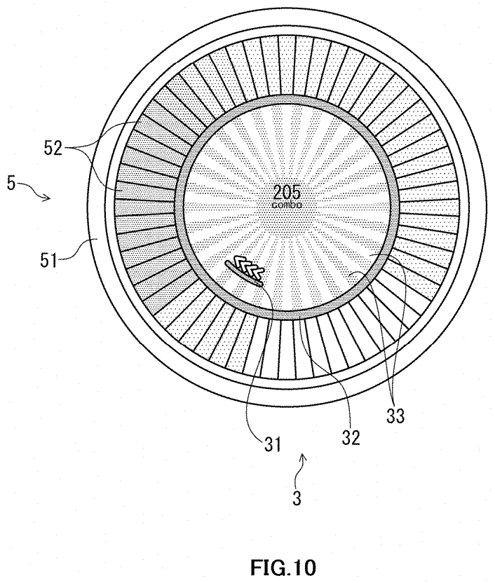

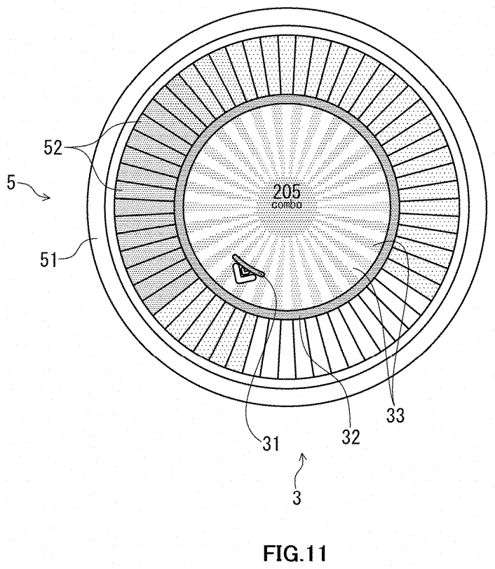

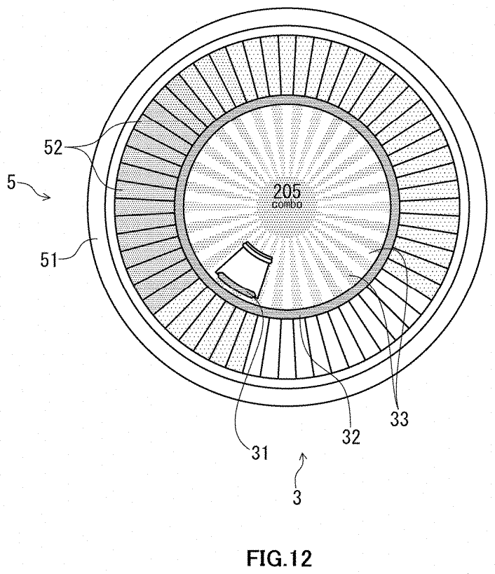

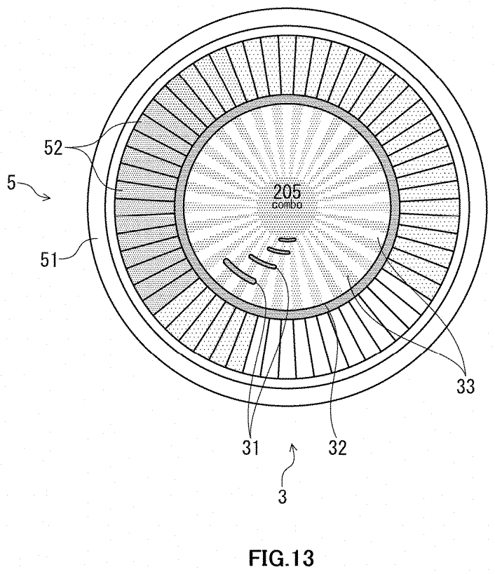

Next, description will be made on the evaluation of the operation inputs of the five types of notes 31 in detail with reference to the drawings. FIG. 10 is a view for explaining a slid operation of the game device according to the first embodiment of the present invention. FIG. 11 is a view for explaining a snap operation of the game device according to the first embodiment of the present invention. FIG. 12 is a view for explaining a hold operation of the game device according to the first embodiment of the present invention. FIG. 13 is a view for explaining a chain operation of the game device according to the first embodiment of the present invention.

(1) Normal Notes

When the normal notes 31 overlap the determination line 32, the player taps the operation members 52 corresponding to the lane 33 on which the normal notes 31 moves. For example, as shown in FIGS. 8 and 9, in the case of the normal notes 31, even if the operation input in any area of the operation member 52 is received, the operation is determined as the success.

(2) Slide Operation

When the slide notes 31 overlap the determination line 32, the player slides the operation members 52 corresponding to the lanes 33 in which the slide notes 31 moves in a direction instructed by the supplementary image. For example, as shown in FIG. 10, in the case of the left slide notes, when the operation input is received in any area of the operation members 52 and then the operation input is not received, the slide operation is evaluated as the success. In other words, the player performs the operation input in any area of the operation member 52 and performs the slide operation in the left direction. At this time, when the player slides beyond the operation member 52, the game processing unit 81 does not receive the information of the operation input. As a result, the evaluation unit 83 evaluates the slide operation as the success.

(3) Snap Input

When the snap notes 31 overlap the determination line 32, the player slides (or taps) the operation members 52 corresponding to the lanes 33 in which the snap notes 31 moves in the direction instructed by the supplementary image. As shown in FIG. 11, in the case of the lower snap notes, when the operation input stored in the success area table is received, the snap operation is evaluated as the success. For example, when the player slides from the first area 521 to the second area 522 of the operation member 52, the evaluation unit 83 evaluates the snap operation as the success.

(4) Hold Operation

When the hold notes 31 overlap the determination line 32, the player continues to touch the operation members 52 corresponding to the lanes 33 in which the hold notes 31 moves while the hold notes 31 is displayed. For example, as shown in FIG. 12, in the case of the hold notes, even if the operation input is received in any area of the operation member 52, the hold operation is evaluated as the success as long as the hold notes 31 has received the operation input while being displayed.

(5) Chain Operation

When the chain notes 31 overlap the determination line 32, the player touches the operation members 52 corresponding to the lanes 33 in which the chain notes 31 move. If the chain notes 31 are continuous, it is not necessary to touch the operation members 52 corresponding to the second subsequent chain notes 31. In this case, the operation input of the operation members 52 corresponding to the second subsequent chain notes 31 is also succeeded by continuing to touch the operation members 52 corresponding to the first chain notes 31. For example, as shown in FIG. 13, in the case of the chain notes 31, even if the operation input on any area of the operation member 52 corresponding to the first chain notes 31 is received, the chain operation is evaluated as the success as long as the corresponding operation members 52 have been touched.

As described above, in the game device 1 of the present invention, the operation unit 5 is formed into the cylindrical shape and arranged so as to project from the display unit 3. Therefore, the information around the game device 1 can be excluded, so that it is possible give the player the sense of immersion to the game. Further, the lanes 33 of the display unit 3 and the operation members 52 are arranged in a straight line. Therefore, it is possible to give the player a sense that the moving distance of the notes 31 is twice as long as the actual moving distance (the length of the lane), so that it is possible to give the sense of spurting of the game. Thus, it is possible to provide a novel game which is not conventionally available.

### 3. Method of Operating Game Device

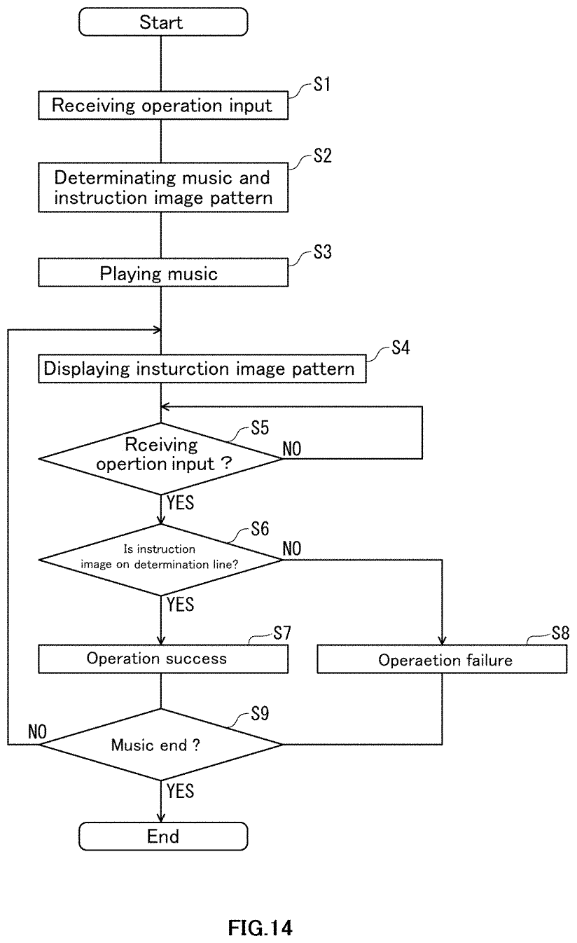

Next, description will be made on an operation method of the game device of the present embodiment in detail. FIG. 14 is a flowchart showing a flow of game processing of the game device according to the first embodiment of the present invention.

First, the operation input for selecting the music is received from the player (S1). When the game processing unit 81 receives the operation input, the game processing unit 81 determines the music and the instruction image pattern corresponding to the music based on the operation input (S2). Thus, the sound output control unit 84 controls the output of the music to come from the speaker 7 (S3). At the same time, the display control unit 82 controls the display of the instruction image pattern, and the display unit 3 displays the instruction image pattern in accordance with the music (S4).

Next, the game processing unit 81 determines whether or not the operation input from the player has been received (S5). If it is determined that the game processing unit 81 has not received the operation input, the processing repeats the step S5. On the other hand, if it is determined that the game processing unit 81 has been received the operation input, the processing proceeds to the step S6.

In the step S6, the game processing unit 81 determines whether or not the instruction image 31 is on the determination line 32 (S6). That is, the game processing unit 81 determines whether or not the operation input has been received at the timing when the instruction image 31 is on the determination line 32. If the game processing unit 81 determines that the instruction image 31 is on the determination line 32, the evaluation unit 83 evaluates the operation as the success (S7). As a result, the processing proceeds to the step S9. On the other hand, if the game processing unit 81 determines that the instruction image 31 is not on the determination line 32, the evaluation unit 83 evaluates the operation as a failure (S8). As a result, the processing proceeds to the step S9.

In the step S9, the game processing unit 81 determines whether or not the music ends (S9). If the game processing unit 81 determines that the music has ended, the processing ends. On the other hand, if the game processing unit 81 determines that the music has not ended, the processing returns to the step S4, and then the steps S4 to S9 are repeated.

The processing as described above is a basic processing of the game. In particular, the processing is applicable to a case where the operation unit 5 receives the inputs of the tap operation, the hold operation and the chain operation. However, when the operation unit 5 receives the inputs of the slide operation and the snap operation, the criteria for determining by the evaluation unit 83 are different. Hereinafter, description will be made on a processing of a case where the inputs of the slide operation and the snap operation are received.

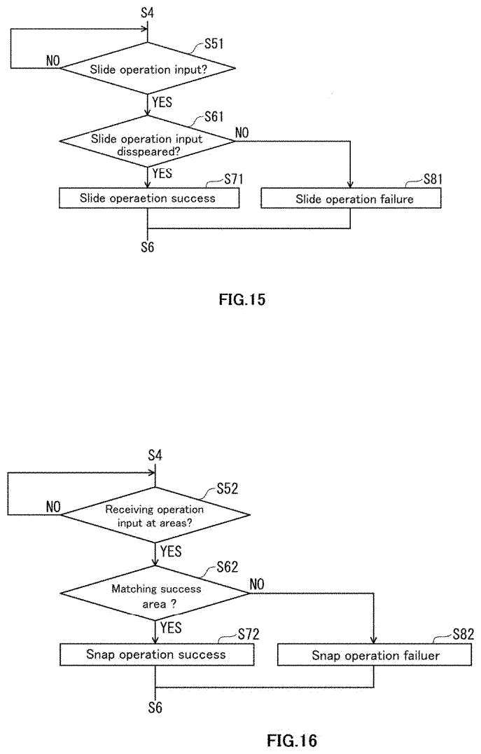

First, description will be made on the processing in the case where the slide operation input is received. FIG. 15 is a flowchart showing a flow of the slide operation of the game device according to the first embodiment of the present invention. After the display unit 3 displays the instruction image pattern in the step S4 of FIG. 14, the processing proceeds to the step S51 shown in FIG. 15.

In the step S51, the game processing unit 81 determines whether or not the slide operation input is received from the player (S51). If it is determined that the game processing unit 81 has not received the slide operation input, the processing repeats the step S51. On the other hand, if it is determined that the game processing unit 81 has received the slide operation input, the processing proceeds to the step S61.

In the step S61, the game processing unit 81 determines whether or not the slide operation input has disappeared (S61). In other words, after the player starts the sliding operation on the operation members 52, the game processing unit 81 determines whether or not the operation input has not received on the operation members 52. If the game processing unit 81 determines that the slide operation input has disappeared, the evaluation unit 83 determines that the slide operation is successful (S71). As a result, the processing proceeds to the step S6 in FIG. 14. On the other hand, if the game processing unit 81 determines that the slide operation input has not been disappeared, the evaluation unit 83 determines that the slide operation has failed (S81). Instead of that, the evaluation unit 83 evaluates that the normal operation is successful. As a result, the processing proceeds to the step S6 in FIG. 14.

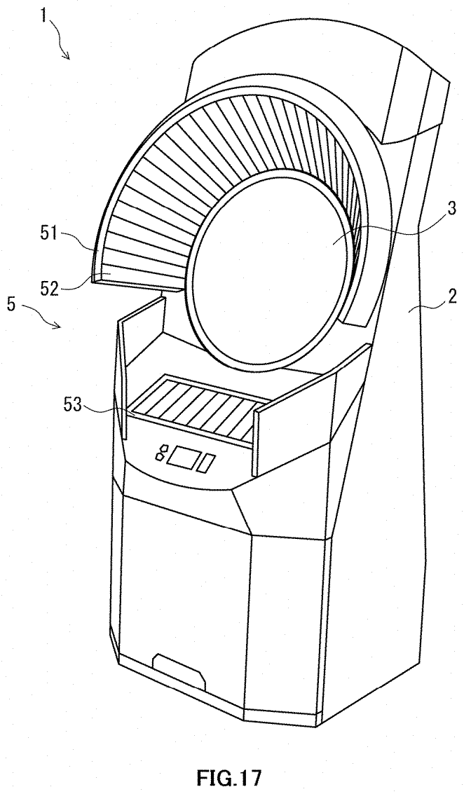

Next, description will be made on the processing of the case where the snap operation input is received. FIG. 16 is a flowchart showing a flow of the snap operation of the game device according to the first embodiment of the present invention. After the display unit 3 displays the instruction image pattern in the step S4 of FIG. 14, the processing proceeds to the step S52 shown in FIG. 16.

In the step S52, the game processing unit 81 determines whether or not the operation input is received in the plurality of areas 521 to 524 of the operation members 52 from the player (S52). If it is determined that the game processing unit 81 has not received the operation input in the plurality of areas 521 to 524, the processing repeats the step S52. On the other hand, if it is determined that the game processing unit 81 has received the operation input in the plurality of areas 521 to 524, the processing proceeds to the step S62.

In the step S62, the evaluation unit 83 refers to the success area table, and then determines whether or not the operation input in the plurality of areas 521 to 524 matches the success area stored in the success area table (S62). For example, in the case where the game processing unit 81 receives a continuous operation input in the third area 523 from the second area 522, the evaluation unit 83 refers to the success area table and then determines whether or not the operation input matches the combination of the success area table. If the evaluation unit 83 evaluates that they match, it is determined that this snap operation is successful (S72). As a result, the processing proceeds to the step S6 in FIG. 14. On the other hand, the evaluation unit 83 determines that they do not match, it is determined that the snap operation is failed (S82). Instead of that, the evaluation unit 83 evaluates that the normal operation is successful. As a result, the processing proceeds to the step S6 in FIG. 14.

As described above, the processing method can be created with a program executed by a computer. Such a program is realized by the CPU (central processing unit), a microprocessor (micro processor), a GPU (graphic processing unit), a RAM (Random Access Memory), a ROM (Read Only Memory), and the like,

### Second Embodiment

Next, description will he made on a second embodiment of the game device of the present invention with reference to the attached drawings.

FIG. 17 is a perspective view schematically showing a game device according to a second embodiment of the present invention. Hereinafter, description will be made on the second embodiment by focusing on different points from the first embodiment described above and descriptions on the common points are omitted. It is to be noted that the same reference numerals are given to the same configurations as those of the first embodiment described above.

The game device 1 of the present embodiment is the same as the game device 1 of the first embodiment except that the configuration of the operation unit 5 is different. Specifically, as shown in FIG. 17, the operation unit 5 of the present embodiment includes an arch-shaped first operation unit and a plate-shaped second operation unit 53.

The arch-shaped first operation unit includes an arch-shaped main body 51 and a plurality of operation members 52 provided continuously on the inner peripheral surface of the main body 51. The first operation unit has a size of ½ of that of the operation unit 5 of the first embodiment. That is, the first operation unit is constituted from thirty operation members 52.

The plate-shaped second operation unit 53 includes a plate-shaped main body and a plurality of operation members 52 provided continuously on an upper surface of the main body. The second operation members 53 may be constituted from thirty operation members 52 corresponding to the thirty lanes of the game area or may be constituted from ten operation members 52 corresponding to arbitrary ten lanes. By providing such second operation unit 53, it is possible to give the player the sense of spurting and the sense of immersion to the game while maintaining operation configurations of conventional game devices. Therefore, a beginner of the game can easily play the game with the game device 1 of the present invention. It is note that the game device 1 of the present embodiment also has the same effects as the effects of the game device 1 of the first embodiment.

### Third Embodiment

Next, description will be made on a third embodiment of the game device of the present invention with reference to the attached drawings.

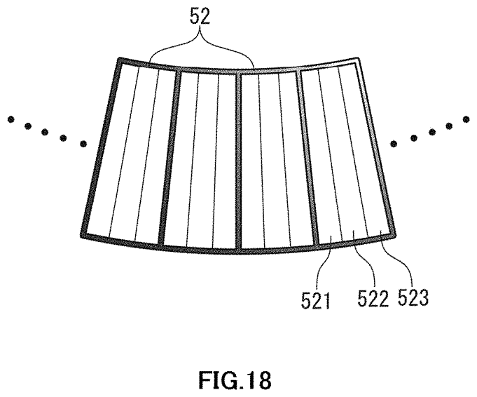

FIG. 18 is a perspective view schematically showing a game device according to a third embodiment of the present invention. Hereinafter, description will be made on the third embodiment by focusing on different points from the first embodiment described above and descriptions on the common points are omitted. It is to be noted that the same reference numerals are given to the same configurations as those of the first embodiment described above.

The game device 1 of the present embodiment is the same as the game device 1 of the first embodiment except that a dividing direction of the operation members 52 is different. Specifically, the operation members 52 of the operation unit 5 of the game device 1 of the third embodiment are divided into three areas along a direction perpendicular to the longitudinal direction thereof. In other words, each of the areas 521 to 522 is formed into an elongated shape along the longitudinal direction of the operation members 52. With such a configuration, since the slide operation is evaluated in the same manner as the snap operation of the first embodiment, it is possible to make the evaluation at the time of the slide operation difficult. Accordingly, it is possible to provide games that can be enjoyed by the advanced-level players as well. It is noted that the game device 1 of the present embodiment also has the same effects as the effects of the game device 1 of the first embodiment.

Although the game device of the present invention has been described based on the preferred embodiments, the present invention is not limited to this. The configuration of each part can be replaced with an arbitrary configuration having the same function. In addition, any other means or compositions may be added to the present invention. Further, the present invention may be a combination of two or more arbitrary configurations (features) among the above embodiments.

### INDUSTRIAL APPLICABILITY

The game device of the present invention as described above includes an operation unit for receiving an operation input from a player, a display unit for displaying an image for instructing the operation input to the operation unit, and a control unit for controlling display of the image. At least a part of the operation unit is provided at the vicinity of the display unit so as to protrude from the display unit. This configuration makes it possible to give the player a sense of immersion and a sense of spurting of a video game. Accordingly, the present invention has industrial applicability.

### EXPLANATION OF REFERENCE NUMERAL

1 Game device

### 2 Housing

3 Display unit
31 Instruction images (Notes)
32 Determination line
33 Plurality of lanes
34 Evaluation image
4 Storage unit
5 Operation unit
51 Main body
52 Operation members
521 First area
522 Second area
523 Third area
524 Fourth area
53 Second operation unit
6 Communication unit

### 7 Speaker

8 Control unit
81 Game processing unit
82 Display control unit
83 Evaluation unit
84 Sound output control unit

1. A game device comprising:
an operation unit for receiving an operation input from a player;
a display unit for displaying an image for instructing the operation input to the operation unit; and
a control unit for controlling display of the image,
wherein at least a part of the operation unit is provided at the vicinity of the display unit so as to protrude from the display unit.

2. The game device as claimed in claim 1, wherein the operation unit is provided on the display unit.

3. The game device as claimed in claim 1, wherein the operation unit is formed into a cylindrical shape.

4. The game device as claimed in claim 1, wherein a protrusion angle of the operation unit with respect to the display unit is in the range of 90 to 150°.

5. The game device as claimed in claim 1, wherein the operation unit is constituted from a plurality of operation members arranged in series.

6. The game device as claimed in claim 5, wherein the operation unit includes a cylindrical main body and the plurality of operation members, and the plurality of operation members is arranged along an inner peripheral surface of the main body.

7. The game device as claimed in claim 5, wherein the image includes a plurality of instruction images, and the plurality of operation members are provided so as to correspond to the plurality of instruction images in a direction in which the plurality of instruction images moves.

8. The game device as claimed in claim 5, wherein the plurality of operation members is divided into a plurality of areas along a longitudinal direction thereof.

9. The game device as claimed in claim 5, wherein at least one operation member of the plurality of operation members includes a plurality of touch sensors as a detection device.

10. The game device as claimed in claim 5, wherein a length of the plurality of operation members is 50 to 150% with respect to a distance in which the plurality of instruction images moves.
